(19) United States
(12) Patent Application Publication
(10) Pub. No.: US 2004/0175094 A1
(43) Pub. Date: Sep. 9, 2004

(54) A PERSONAL VIDEO RECORDER STORING DIGITAL INFORMATION IN A DOUBLY LINKED LIST

(75) Inventors: Craig D. Mautner, San Diego, CA (US); James B. Fahy, Del Mar, CA (US); David M. Eltinge, Encinitas, CA (US)

Correspondence Address: DVA / PIONEER DIGITAL TECHNOLOGIES, SUITE 200, 2355 MAIN STREET, IRVINE, CA, 92614, US

(73) Assignee: PIONEER DIGITAL TECHNOLOGIES, INC., San Diego, CA (US)

(21) Appl. No.: 10/248,961

(22) Filed: Mar. 5, 2003

(51) Int. Cl. H04N 5/76; H04N 5/781

(52) U.S. Cl. 386/46; 386/125

(57) ABSTRACT

A portion of a video and/or audio stream of information is stored in a buffer memory as a plurality of data blocks connected together by a doubly linked list. This lets a user view television programs in a time-shifted mode and apply functionality to the television programs such as forward, reverse, playback, and skipping commercials.

### BACKGROUND OF INVENTION

1. Field of the Invention

The present invention relates generally to video and audio broadcast recording and playback systems.

2. Background of the Invention

The Personal Video Recorder (PVR) lets the viewer view television programs in a time shifted mode so that the viewer can digitally record programs and apply VCR-like functionality to TV programming. For example, the PVR lets the viewer pause, replay, fast-forward, or skip over advertising while viewing a live TV program.

To implement the time-shifted functionality, the broadcast signal is recorded to a rapidly accessible memory which may include some combination of a hard disk and random-access memory. In the design of a PVR, it is critical to organize the digital information so that memory is rapidly freed and the available memory used efficiently.

Previous systems have stored data for a television program contiguously as one block in memory. It is desirable to find improved methods of storing data so as to improve performance and reliability of the system.

### SUMMARY OF INVENTION

To achieve these objectives and advantages, the present invention has an underlying architecture which supports the PVR functionality based on digital information stored in a doubly linked list of data blocks. The data blocks are of a small size which can be mapped into meaningful content. The main reason for this method is to facilitate an efficient buffering technology that will allow a user to fast-forward or rewind live content, while at the same time, enabling the system to archive meaningful groups of content by joining these smaller data blocks. Other advantages of these smaller data block sizes are efficient use of storage space and ease of management in particular releasing earlier data when it has aged beyond the window of recorded data desired.

In one aspect of the present invention, an input mechanism is configured to receive a stream of digital information. A buffer memory is comprised of a plurality of data blocks connected together as a doubly linked list wherein each of the blocks contains a portion of the digital information. A control mechanism operates on the digital information according to one or more control commands.

In another aspect of the present invention, the buffer memory comprises a hard disk and each one of the data blocks comprises one or more sectors of the hard disk.

In a further aspect of the present invention, a tuner is configured to convert an analog broadcast signal to the digital information. An encoder then compresses the digital information.

A further aspect of the present invention comprises a hard disk, a first tuner, a first encoder, a second tuner, and a second encoder. The first tuner converts a first analog broadcast signal to the digital information. A first encoder compresses the digital information to be stored in the buffer memory. A second tuner coverts a second analog broadcast signal to second digital information. The second encoder compresses the second digital information to be stored on the hard disk.

In another aspect of the present invention, the first tuner converts and compresses the digital information to be stored in the buffer memory as a first linked list. The second tuner converts and compresses the second digital information to be stored in the buffer memory as a second doubly linked list.

In still another aspect of the present invention, a decoder decompresses the digital information retrieved from the buffer memory. A video display is configured to display the decompressed digital information as a television program so that a viewer of the program views and operates on the digital information according to one of the control commands.

In yet another aspect of the present invention, there is a plurality of data structures corresponding, respectively, to each of the plurality of data blocks. Each of the data structures comprises a content pointer, a previous pointer and a next pointer. The content pointer points to one of the data blocks. The previous pointer points to a data structure for a previous one of the data blocks. The next pointer points to a data structure for a next one of the data blocks. Thus, the doubly linked list of the data blocks is formed.

In another aspect of the present invention, there is a plurality of data structures corresponding, respectively, to each of the plurality of data blocks. Each of the data structures contains one of the data blocks. Each of the data structures comprises a previous pointer and a next pointer. The previous -pointer points to a data structure for a previous one of the data blocks and the next pointer points to a data structure for a next one of the data blocks, thus forming said doubly linked list of the data blocks.

In a further aspect of the present invention, one of the control commands is a forward command wherein the current position is set to each pointer of a path of pointers formed by following the next pointer of the doubly linked list.

In yet a further aspect of the present invention, one of the control commands is a reverse command wherein the current position is set to each pointer of a path of pointers formed by following the previous pointer of the doubly linked list.

In still another aspect of the present invention, one of the commands is a skip commercial command wherein a commercial being a sub-list of the doubly linked list is removed from the doubly linked list by altering the contents of pointers of the doubly linked list.

In another aspect of the present invention, there is provided a hard disk storage. One or more of the data blocks is moved from the buffer memory to the hard disk storage.

### BRIEF DESCRIPTION OF DRAWINGS

In order to facilitate a fuller understanding of the present invention, reference is now made to the appended drawings. These drawings should not be construed as limiting the present invention, but are intended to be exemplary only.

FIG. 1 is a functional block diagram of an embodiment of a personal video recorder according to the present invention.

FIG. 2 shows the data flow to and from the buffer memory according to the present invention.

FIG. 3a shows a doubly linked list of data blocks stored in the buffer memory according to the present invention.

FIG. 3b shows a second embodiment of a doubly linked list of data blocks stored in buffer memory according to the present invention.

FIG. 4 shows an implementation of skipping a commercial using a doubly linked list of data blocks according to the present invention.

FIG. 5 shows a method of forming and operating on a doubly linked list of data blocks according to the present invention.

FIG. 6 shows a program stored onto a hard disk while another program is being stored in buffer memory according to the present invention.

FIG. 7 shows two programs being stored at the same time into two separate doubly linked lists of buffer memory according to the present invention.

### DETAILED DESCRIPTION

DETAILED DESCRIPTION OF A PREFERRED EMBODIMENT

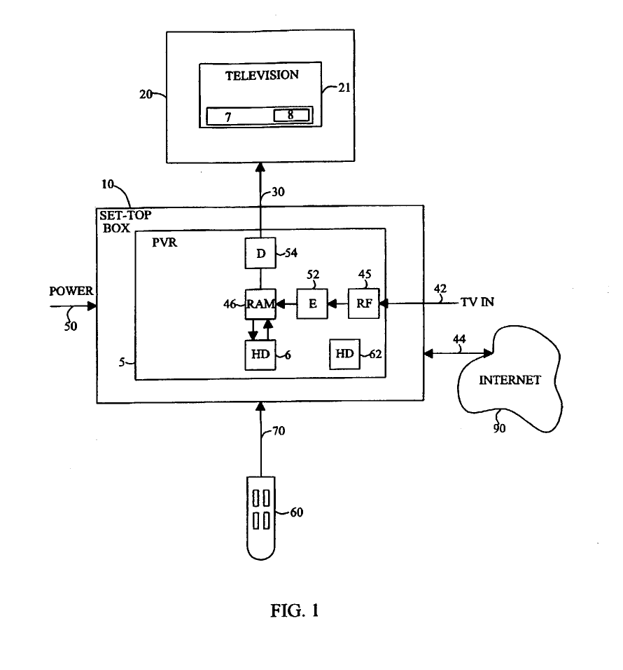

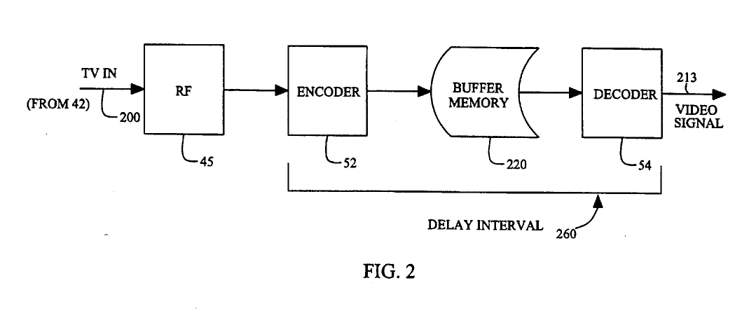

Referring to FIG. 1, the set-top box 10 which couples various broadcast signals 200 (FIG. 2) via communications path 42 to a video display unit 20 contains functionality which enables the display of video programming from the broadcast signals 200, as well as display of a graphical user interface (GUI) 7 and an interactive program guide (IPG) 8 on the video screen 21 of the video display unit 20. The set-top box 10 connects to the video display unit 20 via an electrical interface 30 (for example, a cable) which facilitates the use of the broadcast signals 200 such as live television signals and video on demand broadcasts. The set-top box 10 is also able to download Internet content, view web pages, and view content recorded by the PVR 5. The IPG 8 displays a list of broadcasts that are available by tuning to different channels. The GUI 7 allows the user to navigate the IPG 8, for instance, by viewing different times and dates for broadcasts.

Set-top box 10 receives power through a line 50. Set-top box 10 receives user input entered from the handheld remote control 60 over the wireless link 70. The wireless link 70 may be an infrared (IR) link, a radio frequency (RF) link, or any other suitable type of link. A bi-directional data path 44 is provided to set-top box 10, through which set-top box 10 can access the Internet 90.

The GUI 7 in conjunction with IPG 8 allows the user to control the PVR 5 with the remote control 60. The software or firmware that controls set-top box 10 may be installed locally or it may be downloaded from the Internet 90 as needed or it may be downloaded over the same medium providing video input 200 when configuring new set-top boxes or when updating existing ones.

Referring again to FIG. 1, the PVR 5 can be an external component or, alternately, a component internal to the set-top box 10. The PVR 5 includes some or all of a combination of software, hardware, and firmware. In one embodiment, the PVR 5 uses a disk drive 6 that is internal to the set-top box 10 where broadcasts are recorded. The broadcast signals 200 (such as live television signals, video on demand broadcasts, see FIG. 2) are received by the set-top box 10 via communication path 42, which may be connected to either an antenna or a cable television outlet.

One or more tuner systems 45 are configured to allow the system to receive broadcast signals 200 over communication path 42 from the multiple channels. The tuner system 45 works in conjunction with the random access semiconductor memory 46 so that for each tuner in the system, each can simultaneously record or display channels up to the given number of tuners. The video signal 200 at path 42 is received by the tuner 45 which demodulates the video signal resulting in a baseband digital stream. The tuner 45 may also embody other functions which prepare the video stream for storage, such as an analog-to-digital converter to convert an analog video signal to a digital form. The encoder 52 compresses the digital stream according to a video standard. For example, limited storage capacity is used efficiently by compressing the digital stream using an algorithm, typically one of the MPEG (Moving Pictures Experts Group) standard algorithms, which can achieve a useful compression of 100:1 in many cases. The compressed digital information of the video stream is then stored initially in the random access semiconductor memory 46 and then possibly transferred to a permanent storage 6, for example a hard disk or optical disk. To prepare the contents for viewing, the digital information in the memory 46 is sent to the decoder and decompressed via the decompressor 54. The decompressed digital information is then sent via the communication path 30 to be viewed on the television screen 21 of the video display unit 20. The microcontroller 62 operates under program control to form commands that operate on the data of the buffer memory 220 as described below.

FIG. 2 shows the data flow starting from reception of the broadcast signal 42, processing and storing the broadcast signal 42, and ending with display of a program of the broadcast signal on the video screen 21. As mentioned above, the broadcast signal 200 is converted to digital information by tuner 45 (e.g, demodulation) and then compressed by encoder 52 to digital information suitable for storage in the buffer memory 220. The buffer memory 220 comprises some combination of the semiconductor memory 46 and a portion of the hard disk 6. Typically, the buffer memory 220 comprises the entire hard disk 6. After the digital information leaves buffer memory 220, the digital information is decoded by decoder 54 and the outgoing video signal 213 is displayed on the television 20. It should be noted that a delay interval 260 of a given (x) number of seconds occurs between the time the signal reaches encoder 52 and is output by decoder 54. Therefore, a live TV signal is typically a signal that has been delayed by (x) seconds. If a user is watching a program and is currently recording the program as well, the buffer memory 220 is not used for decoding until the program is paused or rewound. This embodiment is used for analog use of a live TV signal. In an alternate embodiment for digital channels, the encoder blocks are removed.

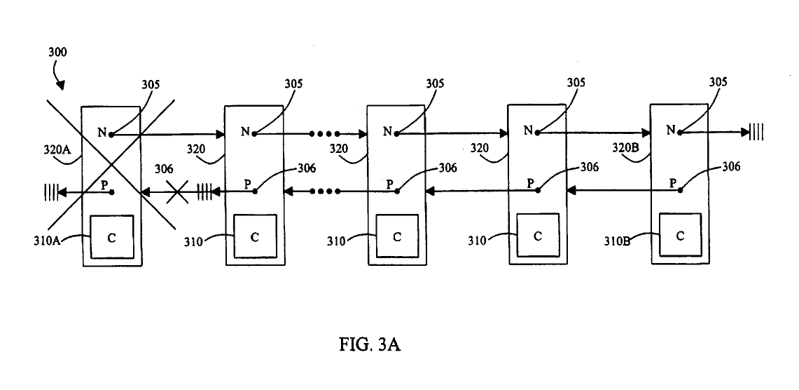

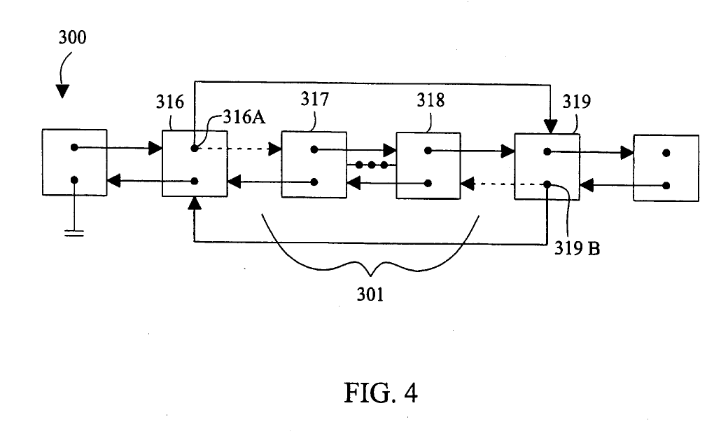

FIG. 3a shows the data structure of the buffer memory 220 to be in the form of a doubly linked list 300 according to the present invention. A doubly linked list is known alternately as a two-way linked list or a symmetrically linked list. A method of operating on the digital information according to the present invention is shown in FIG. 5. The data received at step 410 (see FIG. 5) from video stream 200 from broadcast signal 42 is divided into a plurality of data blocks 310 at step 420 (FIG. 5). Next, at step 430 a doubly linked list 300 is formed. The sequence of the data information is maintained by the plurality of data structures 320. Each of the data structures 320 comprises a next pointer 305 and a previous pointer 306. The data structures 320 contain the data blocks 310. A new data block 310b is added to the memory 220 by creating a new data structure 320b at the end of the list 300. At the same time as the new data structure 320b is created, the data structure 320a at the beginning of the list 300 is removed from the beginning of the list 300. Thus, by removing the pointer 320a from the beginning of the list, the memory block 310a is released to the memory 220. Thus, as data blocks 310 are freed up and added to the memory 220, other data blocks are taken from the memory 220 and added to the end of the list 300. This aids with wear-leveling so that the hard disk 6 doesn't reuse the same set of sectors over and over. This buffer implements a buffer memory which supports the VCR-like functionality on live TV programming. The first pointer of the list 300 has its previous pointer set to a null value.

FIG. 3b shows a second embodiment of the data structure in the buffer memory 220 to be in the form of a doubly linked list 302 according to the present invention. Each of the data structures 320 comprises a next pointer 305, a previous pointer 306, and a content pointer 307 which points to the data block 310. A new data block 310b is added to the memory 220 by creating a new data structure 320b at the end of the list 302. At the same time as the new data structure is created, the data structure 320a at the beginning of the list 302 is removed from the beginning of the list. Thus, by removing the data structure 320a from the beginning of the list, the memory block 310a is released to the memory 46. Thus, as data blocks 310 are freed up and added to the memory 220, other data blocks are taken from the memory 220 and added to the end of the list 302. This aids with wear-leveling so that the hard disk 6 doesn't reuse the same set of sectors over and over.

The methods of managing a doubly linked list as shown in FIG. 3a and FIG. 3b both determine and fix the size of the doubly linked list, which assures that the doubly linked list does not consume the entire buffer memory 200. Preferably, the data blocks 320 are all sets of sectors on the hard disk drive 6.

The digital information from the video stream 200 is compressed and divided into the plurality of data blocks 310 which are connected together as the doubly linked list 300 or doubly linked list 302. The microprocessor 62 operates on the doubly linked lists 300, 302 according to one or more control commands in step 440 (see FIG. 5). The microprocessor 62 performs, but is not limited, to VCR-like functions performed on the doubly linked lists 300, 302 three of which are described below. The flexibility afforded by the memory management with doubly linked lists additionally allows functions not traditionally performed on a VCR like a function to skip commercials. The following commands are described as being performed on doubly linked list 300, but the same actions are performed on doubly linked list 302.

In response to the FORWARD command, the microprocessor 62 follows a path of the doubly linked list 300 formed by the next pointers 305. That is, the current position is set, in turn, to each pointer 320 of the path of pointers formed by following the next pointers 305 of the doubly linked lists 300. The current position pointer is maintained by the microprocessor 62 to indicate the most recent pointer being processed.

In response to the REVERSE command, the microprocessor 62 follows a path of the doubly linked lists 300 formed by the previous pointers 306. That is, the current position of playback is set to each pointer 320 of a path of pointers formed by following the previous pointer 306 of the doubly linked lists 300.

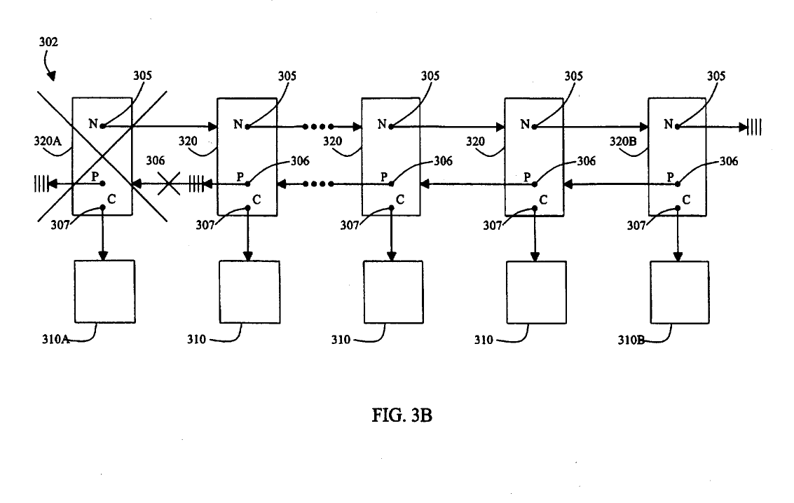

In the response to the SKIP COMMERCIAL command, referring to FIG. 4, the microprocessor 62 deletes a commercial from the doubly linked list 300. A commercial is a sub-list 301 of the doubly linked list 300 designated by a pointer 317 to the beginning of the sub-list 301 and another pointer 31 8 to the end of the sub-list 301 (the content pointers to data blocks 310 are not shown). The commercial 301 is easily deleted by changing the pointers as shown in FIG. 4. More specifically, the next pointer 316a is changed from pointing to pointer 317 so that it points to block 319. The previous pointer 319b of block 319 is changed from pointing to pointer 318 so that it now point to the pointer 316. Thus, the commercial segment consisting of the pointers forming a chain from pointer 317 to 318 and the data blocks 310 pointed to by these pointers are excised from the commercial segment 301.

In response to the RECORD command, the microprocessor 62 moves the data blocks 310 to a more permanent memory such as the hard disk 6. One or more of the data blocks 310 from the doubly linked list 300 of the buffer memory 220 is moved to the hard disk storage 6.

Additionally, data blocks 310 are being moved to the hard disk automatically by the operating system of the present invention as data blocks 310 are formed from the data information of the broadcast signal 42.

Thus, the present invention supports operations, sometimes referred to as virtual VCR functions, such as pause, rewind, fast forward, and play, as well as more sophisticated functions such as play faster, slower, and play in reverse.

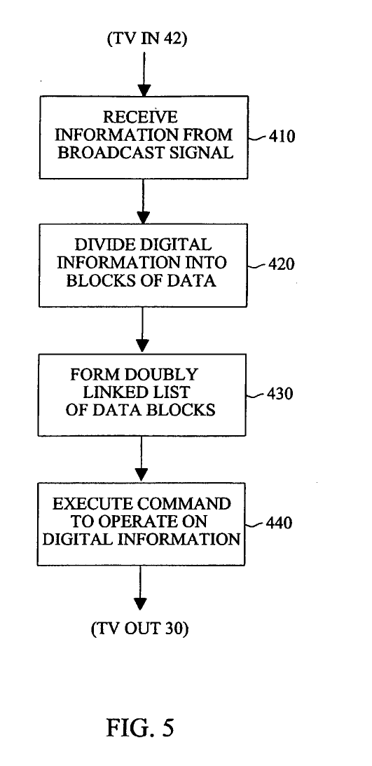

FIG. 6 shows two tuners 45a and 45b of tuner system 45 according to the present invention. In this embodiment, the broadcast signal 200 comprises a first broadcast signal 200a carrying a first program and a second broadcast signal 200b carrying a second program. The first broadcast signal 200a is converted to digital information by tuner 45a and then compressed by encoder 52a to digital information suitable for storage on the hard disk 6. The second broadcast signal 200b is converted to digital information by tuner 45b and then compressed by encoder 52b to digital information suitable for storage in the buffer memory 220. In this embodiment, a user is able to record a first program while simultaneously viewing and performing commands on a second program.

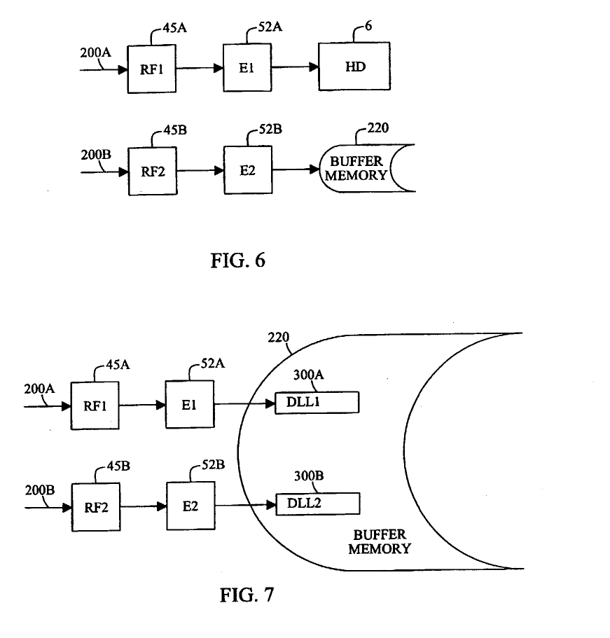

FIG. 7 shows two programs being stored into two separate doubly linked lists of buffer memory 220 according to the present invention. In this embodiment, the broadcast signal 200 comprises a first broadcast signal 200a carrying a first program and a second broadcast signal 200b carrying a second program. The first broadcast signal 200a is converted to digital information by tuner 45a and then compressed by encoder 52a to digital information suitable for storage in the doubly linked list 300a of the buffer memory 220. The second broadcast signal 200b is converted to digital information by tuner 45b and then compressed by encoder 52b to digital information suitable for storage in the doubly linked list 300b in the buffer memory 220. In this embodiment, the user is enabled to use the first program and the second program at the same time, for example, the user may alternate viewing between the first program and the second program.

The present invention is not to be limited in scope by the specific embodiments described herein. Indeed, this application is intended to cover any modifications of the present invention, in addition to those described herein, and the present invention is not confined to the details set forth. Thus, the scope of the invention should be determined by the appended claims and their legal equivalents, rather than by the examples given.

1. An apparatus for operating on a stream of digital information, comprising: a buffer memory comprising a plurality of data blocks connected together as a doubly linked list wherein each of said data blocks contains a portion of said digital information; and a control mechanism configured to operate on said digital information according to one or more control commands.

2. The apparatus of claim 1, wherein said buffer memory comprises a hard disk and each one of said data blocks comprises one or more sectors of said hard disk.

3. The apparatus of claim 1, further comprising: a tuner configured to convert an analog broadcast signal to said digital information; and an encoder configured to compress said digital information.

4. The apparatus of claim 1, further comprising: a decoder configured to decompress said digital information retrieved from said buffer memory; and a video display configured to display said decompressed digital information as a television program so that a viewer of said program views and operates on said digital information according to one of said control commands.

5. The apparatus of claim 1, further comprising: a hard disk; a first tuner configured to convert a first analog broadcast signal to said digital information; a first encoder configured to compress said digital information to be stored in said buffer memory; a second tuner configured to covert a second analog broadcast signal to second digital information; and a second encoder configured to compress said second digital information to be stored on said hard disk.

6. The apparatus of claim 1, further comprising: a first tuner configured to convert a first analog broadcast signal to said digital information in said doubly linked list; a first encoder configured to compress said digital information to be stored in said buffer memory; a second tuner configured to covert a second analog broadcast signal to second digital information; and a second encoder configured to compress said second digital information to be stored in said buffer memory as a second doubly linked list.

7. The apparatus of claim 1, wherein each of said data blocks contains one or more frames of video data.

8. The apparatus of claim 1, further comprising: a plurality of data structures corresponding, respectively, to each of said plurality of data blocks, each of said data structures comprising a content pointer, a previous pointer and a next pointer so that said content pointer points to one of said data blocks, said previous pointer points to a data structure for a previous one of said data blocks and said next pointer points to a data structure for a next one of said data blocks, thus forming said doubly linked list of said data blocks.

9. The apparatus of claim 1, further comprising: a plurality of data structures corresponding, respectively, to each of said plurality of data blocks, each of said data structures containing one of said data blocks, each of said data structures comprising a previous pointer and a next pointer, said previous pointer points to a data structure for a previous one of said data blocks and said next pointer points to a data structure for a next one of said data blocks, thus forming said doubly linked list of said data blocks.

10. The apparatus of claim 1, wherein one of said control commands is a forward command wherein the current position is set to each pointer of a path of pointers formed by following the next pointer of said doubly linked list.

11. The apparatus of claim 1, wherein one of said control commands is a reverse command wherein the current position is set to each pointer of a path of pointers formed by following the previous pointer of said doubly linked list.

12. The apparatus of claim 1, wherein one of said commands is a skip commercial command wherein a commercial being a sub-list of said doubly linked list is removed from said doubly linked list by altering the contents of pointers of said doubly linked list.

13. The apparatus of claim 1, wherein said buffer memory comprises a hard disk storage and one or more of said data blocks is moved to said hard disk storage.

14. A method for operating on digital information from a video or audio stream, comprising the steps of: receiving a stream of digital information; dividing said digital information into a plurality of data blocks; connecting together said data blocks as a doubly linked list wherein each of said data blocks contains a portion of said digital information; and operating on said digital information according to one or more control commands.

15. The method of claim 14, wherein said digital information comprises video information.

16. The method of claim 14, wherein said digital information comprises audio information.

17. The method of claim 14, further comprising the steps of: converting an analog broadcast signal to uncompressed digital information; and compressing said uncompressed digital information to form said digital information for storage in said doubly linked list.

18. The method of claim 14, further comprising the steps of: converting a first analog broadcast signal via a first tuner to said digital information; compress said digital information to be stored in said buffer memory; converting a second analog broadcast signal via a second tuner to second digital information; and compressing said second digital information to be stored on a hard disk.

19. The method of claim 14, further comprising the steps of: converting a first analog broadcast signal via a first tuner to said digital information in said doubly linked list; compressing said digital information to be stored in said buffer memory; converting a second analog broadcast signal via a second tuner to second digital information; and compressing said second digital information to be stored in said buffer memory as a second doubly linked list.

20. The method of claim 14, further comprising the steps of: decompressing said digital information retrieved from said buffer memory; and displaying said decompressed digital information as a television program so that a viewer of said program views and operates on said digital information according to one of said control commands.

21. The method of claim 14, further comprising: a plurality of data structures corresponding, respectively, to each of said plurality of data blocks, each of said data structures comprising a content pointer, a previous pointer and a next pointer so that said content pointer points to one of said data blocks, said previous pointer points to a data structure for a previous one of said data blocks and said next pointer points to a data structure for a next one of said data blocks, thus forming said doubly linked list of said data blocks.

22. The method of claim 14, further comprising:a plurality of data structures corresponding, respectively, to each of said plurality of data blocks, each of said data structures containing one of said data blocks, each of said data structures comprising a previous pointer and a next pointer, said previous pointer points to a data structure for a previous one of said data blocks and said next pointer points to a data structure for a next one of said data blocks, thus forming said doubly linked list of said data blocks.

23. The method of claim 14, wherein one of said control commands is a forward command wherein the current position is set to each pointer of a path of pointers formed by following the next pointer of said doubly linked list.

24. The method of claim 14, wherein one of said control commands is a reverse command wherein the current position is set to each pointer of a path of pointers formed by following the previous pointer of said doubly linked list.

25. The method of claim 14, wherein one of said commands is a skip commercial command wherein a commercial being a sub-list of said doubly linked list is removed from said doubly linked list by altering the contents of pointers of said doubly linked list.

26. The method of claim 14 further comprising: a hard disk storage wherein one or more of said data blocks is moved from said buffer memory to said hard disk storage.

27. A personal video recorder, comprising: a tuner configured to convert a broadcast signal to a baseband digital signal; an encoder configured to compress said baseband digital signal creating digital information ready to be stored; a buffer memory configured to temporarily store said digital information, said buffer memory comprising a plurality of data blocks connected together as a doubly linked list wherein each of said data blocks contains a portion of said digital information; a permanent storage memory for storing said digital information; a control mechanism configured to operate on said digital information in a time shifted mode according to one or more control commands; a decoder configured to decompress said digital information.

28. The personal video recorder of claim 27, further comprising: a video display for displaying said decompressed digital information according to said control commands.
